(19) United States
(12) Patent Application Publication
(10) Pub. No.: US 2016/0189229 A1
(43) Pub. Date: Jun. 30, 2016

(54) Systems and Methods for Targeting Advertising to Prepaid Card Accounts

(71) Applicant: Green Dot Corporation, Pasadena, CA (US)

(72) Inventors: Ajith Gopalan, Pasadena, CA (US); David Gullett, Pasadena, CA (US); Calvin Park, Passadena, CA (US); Kuan Archer, Pasadena, CA (US)

(73) Assignee: Green Dot Corporation

(21) Appl. No.: 14/587,945

(22) Filed: Dec. 31, 2014

(51) Int. Cl. G06Q 30/02; G06Q 20/10

(52) U.S. Cl. CPC G06Q 30/0261; G06Q 30/0251; G06Q 20/10

(57) ABSTRACT

Systems and methods for targeting advertising in accordance with embodiments of the invention are disclosed. In one embodiment, a method for targeting advertising includes obtaining financial transaction data using an account servicing server system, wherein the financial transaction data comprises location data, retailer identification data, and metadata describing reload activity for a prepaid card and the reload activity comprises metadata describing the amount of money deposited in an account associated with the prepaid card, generating targeting data based on the location data, retailer identification data, and the reload activity using the account servicing server system, obtaining advertising data based on the generated targeting data using the account servicing server system, wherein the advertising data comprises at least one offer for a product provided by the retailer identified by the retailer identification data, and providing the advertising data using the account servicing server system.

### FIELD OF THE INVENTION

The present disclosure relates generally to financial services systems, and relates, more particularly, to advertising based on financial transactions.

### BACKGROUND

The financial services industry provides a plethora of financial services to consumers for managing their finances and engaging in financial transactions with retailers and service providers. Consumers can hold funds within many different types of accounts at many different types of financial institutions. Consumers can access the funds held in the accounts using many different types of cards, including credit cards, debit cards, gift cards, and other types of cards based on the particular type of account associated with the card. The cards can be issued from financial institutions, such as banks, credit unions, savings & loans, and brokerage institutions.

A payment processor is a company that handles transactions for one or more financial institutions. Many payment processors have connections to various card associations and supply authorization and settlement services to the financial institutions. Several payment processors facilitate the movement of funds between payment processors and financial institutions. Payment processors verify aspects of proposed transactions. Once the payment processor has received confirmation or denial of the verification, the information can be relayed to the financial institution that can then complete or invalidate the payment transaction accordingly.

### SUMMARY OF THE INVENTION

Systems and methods for targeting advertising in accordance with embodiments of the invention are disclosed. In one embodiment, a method for targeting advertising includes obtaining financial transaction data using an account servicing server system, wherein the financial transaction data includes location data, retailer identification data, and metadata describing reload activity for a prepaid card and the reload activity includes metadata describing the amount of money deposited in an account associated with the prepaid card, generating targeting data based on the location data, retailer identification data, and the reload activity using the account servicing server system, obtaining advertising data based on the generated targeting data using the account servicing server system, wherein the advertising data includes at least one offer for a product provided by the retailer identified by the retailer identification data, and providing the advertising data using the account servicing server system.

In another embodiment of the invention, the method further includes identifying a client device associated with the prepaid card based on the financial transaction data using the account servicing server system, and the advertising data is provided to the client device.

In an additional embodiment of the invention, providing the advertising data further includes transmitting the targeting data to a third party advertising system using the account servicing server system and transmitting the advertising data to the client device using the third-party advertising system.

In yet another additional embodiment of the invention, the advertising data is provided to a point of sale terminal located at the retailer identified based on the retailer identification data.

In still another additional embodiment of the invention, the point of sale terminal is identified based on the financial transaction data.

In yet still another additional embodiment of the invention, the advertising data is utilized to generate an offer redeemable via the point of sale terminal using the point of sale terminal.

In yet another embodiment of the invention, the method further includes obtaining a set of advertising rule data using the account servicing server system, wherein the advertising rule data includes mappings of product data to offer data, generating the targeting data based on the advertising rule data, wherein the generated targeting data includes offer data for products selected based on the financial transaction data and the offer data, and obtaining advertising data including at least one offer for the products described by the advertising rule data.

In still another embodiment of the invention, the advertising rule data is provided by a retailer system associated with the retailer identified by the retailer identification data.

In yet still another embodiment of the invention, the advertising rule data is provided by a third-party retailer system separate and distinct from the retailer identified by the retailer identification data.

In yet another additional embodiment of the invention, the obtained advertising data further includes retailer data identifying a third-party retail location that is located within a threshold distance from the retailer identified in the financial transaction data.

In still another additional embodiment of the invention, the advertising rule data is provided by a third-party advertising system.

In yet still another additional embodiment of the invention, the advertising data is provided by pushing the advertising data to a client device using the account servicing server system.

In yet another embodiment of the invention, the advertising data is pushed to the client device using a short message service message.

In still another embodiment of the invention, the method further includes obtaining transaction verification data using the account servicing server system, wherein the transaction verification data includes metadata describing that a second financial transaction data has been denied and product data describing a product to be purchased via the second financial transaction, determining that an offer associated with the advertising data corresponds to the product to be purchased using the account servicing server system, and transmitting transaction authorization data using the account servicing system.

In yet still another embodiment of the invention, the transaction verification data is obtained from a payment processor system.

In yet another additional embodiment of the invention, the transaction authorization data is transmitted to a financial institution system, wherein the financial institution system holds the account associated with the prepaid card.

In still another additional embodiment of the invention, the overage is equivalent to the amount of the discount applied to the product to be purchased calculated based on price data describing the cost of the product to be purchased and the offer data.

In yet still another additional embodiment of the invention, the method further includes transmitting deposit data to a financial institution system holding the account associated with the prepaid card using the account servicing server system, wherein the deposit data includes an amount of money to be deposited into the account based on the offer data, and the transaction authorization data includes instructions to a payment processor system to re-execute the second financial transaction.

In yet another embodiment of the invention, the transaction authorization data includes metadata describing an authorization to allow an overage on the second financial transaction based on the offer data.

Still another embodiment of the invention includes an account servicing server system including a processor and memory connected to the processor and storing an account servicing application, wherein the account servicing application directs the processor to obtain financial transaction data, wherein the financial transaction data includes location data, retailer identification data, and metadata describing reload activity for a prepaid card and the reload activity includes metadata describing the amount of money deposited in an account associated with the prepaid card, generate targeting data based on the location data, retailer identification data, and the reload activity, obtain advertising data based on the generated targeting data, wherein the advertising data includes at least one offer for a product provided by the retailer identified by the retailer identification data, and provide the advertising data.

### BRIEF DESCRIPTION OF THE DRAWINGS

FIG. 1 is a conceptual illustration of an account servicing system in accordance with an embodiment of the invention.

FIG. 2 is a conceptual illustration of an account advertising server system in accordance with an embodiment of the invention.

FIG. 3 is a flow chart illustrating a process for directly targeting advertising in accordance with an embodiment of the invention.

FIG. 4 is a flow chart illustrating a process for targeting third-party advertising in accordance with an embodiment of the invention.

FIG. 5 is a flow chart illustrating a process for targeting advertising based on transaction data in accordance with an embodiment of the invention.

FIG. 6 is a flow chart illustrating a process for fulfilling presented offers in accordance with an embodiment of the invention.

### DETAILED DESCRIPTION

Turning now to the drawings, systems and methods for targeting advertising in response to account transactions based upon locations associated with the transactions and funds available in the accounts in accordance with embodiments of the invention are illustrated. Account servicing systems in accordance with many embodiments of the invention can detect account activity and target advertising to client devices associated with the active accounts based upon location information associated with or implied by the account transactions (e.g. the location of a point of sale) and/or available account balances. In this way, the account servicing systems enable advertisers to programmatically target advertisements based upon the location of a consumer and the funds available to the consumer account (i.e. the pre-paid card account associated with the consumer). In several embodiments, the account servicing systems directly target advertising to consumer accounts and/or client devices associated with consumer accounts. In a number of embodiments, the account servicing systems provide information identifying consumer accounts and/or client devices associated with consumer accounts as targets to advertising networks that target advertisements to the identified consumer accounts.

Advertisers can present advertisements to consumer accounts through many different advertising channels. For example, consumer accounts are primarily advertised to through television, radio, internet websites, social media, email, billboards, and/or mass-mailings. Advertisements can provide special offers and/or offers that could otherwise provide a potentially significant savings to a consumer account had the consumer account been aware of the offer when making a purchase. However, consumer accounts are often unwilling to invest the time and effort needed to seek out potential savings opportunities given the enormous amounts of advertisements a typical consumer account receives on a daily basis. In particular, a consumer account must often first find offers that are of interest to them and remember to take the offers to a retailer when making the purchase in order to realize any potential savings. Accordingly, many consumer accounts often can totally disregard or ignore many advertisements that would otherwise be very useful to them due to the time and effort required. For example, a consumer account can wish to purchase a particular bicycle from a retailer and can have received an exact offer for that bicycle, but the offer can be hidden alongside tens of hundreds of other offers within the consumer account's “junk” mail. Thus, unless the consumer account sifts through all of their daily communications, they will most likely not come across a particular offer. Furthermore, many consumer accounts simply trash their junk mail and thus miss many possible savings they could otherwise obtain. In many embodiments of the invention, account servicing systems provide advertisements to consumer accounts that are directed to goods and/or services associated with the location of a consumer account and at a time when the consumer account has money available for spending, thereby providing advertisements that can be much more useful to the consumer account. Similarly, account servicing systems can provide valuable targeting data and advertising opportunities to retailers by providing mechanisms for tracking consumer account activity, identifying common locations of consumer accounts, and/or determining when consumer accounts have money available to spend.

Account servicing systems in accordance with many embodiments of the invention can provide advertising data to client devices based on location data and/or financial transaction data related to the consumer account. In a variety of embodiments, account servicing systems determine the location of a consumer account and target advertising to the consumer account. In several embodiments, account servicing systems can identify the location of a consumer account based on received information indicating that the consumer account is engaging in, or has recently engaged in, financial transaction(s) at a particular location associated with a retailer. In a number of embodiments, the financial transaction can include depositing (e.g. reloading) a prepaid card serviced by the account serving system. Any of a variety of systems within the account servicing system can provide data regarding financial transactions as appropriate to the requirements of specific applications of embodiments of the invention.

Purchasing a prepaid card can include requesting that an account be established at a financial institution and/or having a card be associated with and issued by a payment processor system. Similarly, reloading a prepaid card can include facilitating the deposit of funds into an account, managed by a financial institution, associated with a prepaid card. In this way, when a prepaid card is reloaded, the account associated with the prepaid card contains (or will shortly contain) funds that can be immediately used to purchase goods and/or services. This allows for a variety of financial services to be provided to consumer accounts, such as sub-prime consumer accounts, that may otherwise be unable to directly obtain or support accounts with traditional credit card companies and/or financial institutions.

In many embodiments, the prepaid card can be purchased and/or reloaded using a point of sale terminal at a retailer. For example, a consumer account can provide cash, checks, wire deposits, and various other mechanisms in order to add funds to the prepaid card. When the consumer account loads funds onto a prepaid card at a particular location (i.e. at a point of sale terminal), account servicing systems can determine the location of the activity based on the location of the point of sale terminal (or other reload facility). Furthermore, account servicing systems can obtain information regarding the amount of money that the consumer account has recently loaded onto the consumer account's card. In several embodiments, a client device associated with the prepaid card includes location determination capabilities, such as a Global Positioning System (GPS) receiver, and location data determined by the client device can be used to augment the location data describing the location of the point of sale terminal.

In a variety of embodiments, account servicing systems present advertisements to consumer accounts based on the inferred location of a client device associated with a consumer account's account and/or the amount of funds available in the account associated with the prepaid card. In this way, account servicing systems can generate targeting data based on where consumer accounts shop and when they have money to spend. Accordingly, the advertisement that is presented can often be targeted according to the particular location at which the consumer account is currently located (or commonly located) and/or the amount of money that the consumer account has available to spend. For example, if a determination is made that is consumer account is currently located within a particular retailer, an advertisement can be selected for presentation to that consumer account while they are within the store and the advertisement can be related to goods and/or services that are available at the particular retailer. In several embodiments, the targeting data and/or advertising is based on the prior financial transactions and spending habits of the consumer account.

In a number of embodiments, the account servicing server system receives advertising data and/or targeting data from retailers and/or advertisers that would like to market to prepaid card holders. When a consumer account satisfies the particular criteria for a particular advertisement, the consumer account is presented with the advertisement via a client device. In a variety of embodiments, retailers and/or advertisers can be provided with a notification that particular consumer accounts (or classes of consumer accounts) are likely to shop at a retailer in order to facilitate the targeting and/or deployment of advertising to those consumer accounts.

In accordance with the requirements of specific applications of embodiments of the invention, advertising data includes one or more offers than can be redeemed by a consumer account. Offers can include, but are not limited to, offers that can be redeemed to obtain a discount on particular goods and/or result in a credit to the consumer account's account. In a variety of embodiments, advertising data includes a set of offers, where an offer includes a mapping between a particular product and a discount to be applied to the purchase of that product. That is, advertising data can include a set of mappings between product data describing products and offer data describing offers applicable to the products. Account servicing systems can analyze a consumer account's financial transactions and apply offers to the consumer account's account and/or transactions based on transactions that satisfy the criteria of previously presented (and/or accepted) offers presented to the consumer account. In this way, account servicing systems can facilitate the redemption of offers associated with advertising presented to consumer accounts, thereby encouraging consumer accounts to shop at particular retailers. In a number of embodiments, the rewards and/or savings that are being rewarded to a consumer account's account are identified (e.g., highlighted in the consumer account's transaction history) such that the consumer account can become aware of these savings. In a number of embodiments, the consumer account can be notified at the time a purchase is being made that a particular offer (e.g. coupon) is being applied to a transaction. For example, if the regular price of an item is $100, and a consumer account had previously received an offer for 25% off the particular item, then at the time of check-out the consumer account can obtain the 25% discount and pay only $75. In this way, the consumer account's account is debited by $75. By way of another example, the consumer account can initially pay the $100 for the particular item and then their account could be reimbursed for the 25% savings. In this way, the consumer account's account is debited for $100 and a $25 credit is contributed to the consumer account's account. In a variety of embodiments, account servicing server systems instruct payment processor systems to provide a temporary credit in the amount of the specific offer being applied in order to authorize a particular transaction, particularly those transactions where the consumer account's account does not have sufficient funds to fulfill the transaction in the absence of the credit to be applied to the account. In many embodiments, client devices can receive and/or display notifications of the rewards available and/or applied to particular transactions.

### Account Servicing Systems

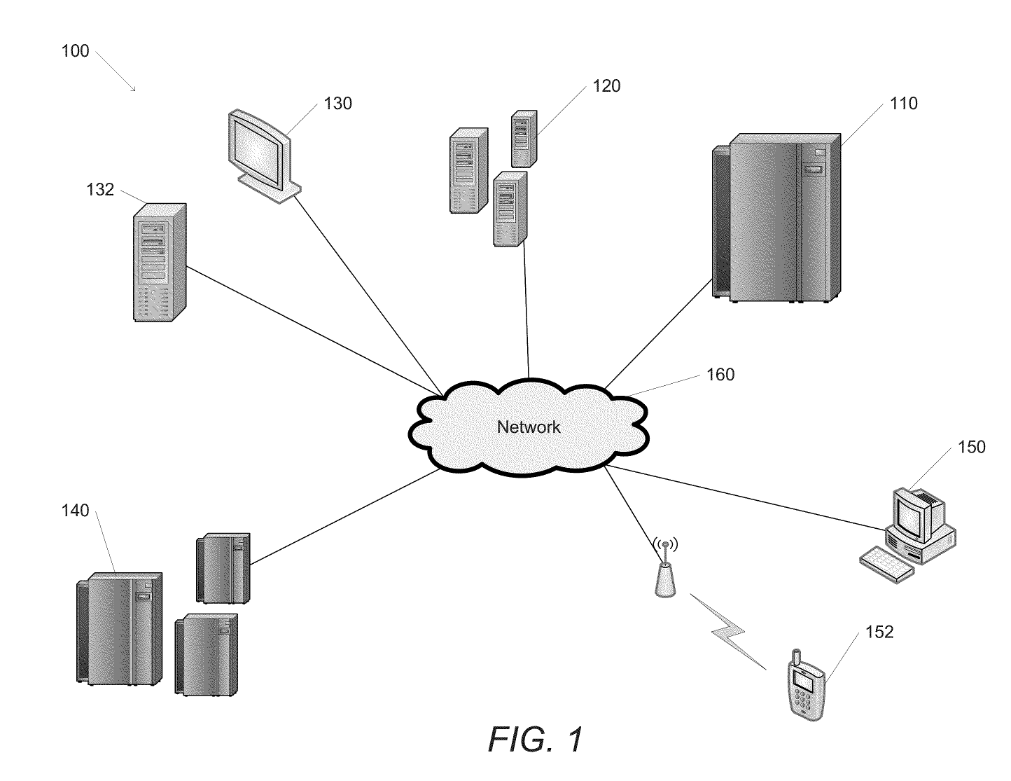

Account servicing server systems in accordance with embodiments of the invention can provide advertisements to consumer accounts based on location and/or financial transactions information associated with a consumer account. As further described below, account servicing systems utilize transaction data associated with a consumer account in order to provide the consumer account with tailored offers and/or advertisements that have been specified by retailers and/or advertisers. Turning now to FIG. 1, a conceptual illustration of an account servicing system in accordance with an embodiment of the invention is shown. The account servicing system 100 includes account processing server system 110, payment processor systems 120, retailer systems such as point of sale terminals 130 and retailer server system 132, financial institution systems 140, and client devices including, but not limited to, personal computers 150 and mobile devices 152. These systems communicate through one or more networks 160. Network(s) 160 can include, but are not limited to, the Internet, a local area network, a wide area network, and networks that are shared privately between only a subset of the systems. For example, the payment processor 120 can communicate with the financial institution systems 140, retailer systems, and account processing server system 110 via one or more private networks.

Account servicing server system 110 provides front-end and back-end services for creating and managing accounts for prepaid cards via a number of account servicing processes as appropriate to the requirements of specific applications of embodiments of the invention. Account servicing server system 110 can obtain account data for a prepaid card from a retailer system and/or from a client device. The account servicing server system 110 can assign the account to a payment processor system 120 and/or financial institution 140; a request that a permanent card be issued to the account holder associated with the account by the payment processor system 120 and/or financial institution 140 can also be made. The account servicing server system 110 can also communicate with the financial institution 140 and/or the payment processor system 120 to facilitate the execution of transactions between consumer accounts and retailer systems when the transaction involves the prepaid card. In many embodiments, the account servicing server system 110 includes some or all of the aspects of the payment processor systems 120 and/or the financial institution systems 140. In a number of embodiments, the retailer systems host their own account servicing server system 110.

The account servicing server system 110 can also provide an interface providing account data, user profile data, balance data, transaction data, fee data, and any other data related to the prepaid card and/or the account as appropriate to the requirements of specific applications of embodiments of the invention. In a variety of embodiments, the account servicing server system 110 provides targeting data and/or advertising data associated with one or more retailers to client devices associated with prepaid card holders. As is described in more detail below, a variety of targeting options can be utilized in order to present advertising data as appropriate to the requirements of specific applications of embodiments of the invention. By way of a first example, targeting data can be providing to retailer systems and/or third-party advertising systems and advertising data can be obtained in response. By way of a second example, information about consumer accounts is used in combination with targeting data from retailers (i.e. advertising rule data) to determine which client devices to target. By way of a third example, a set of advertising data can be pre-loaded onto a client device and, when the client device determines that a set of conditions have been met (e.g. based on the targeting data), an advertisement can be presented based on the pre-loaded advertising data.

In a number of embodiments, the account servicing server system 110 identifies when funds have been loaded onto a prepaid card and provides advertising (or causes advertising to be provided) when a consumer account has money to spend. This identification can be performed based on a variety of transaction data, such as transaction data associated with a consumer account and transaction data describing a reload operation for the consumer account obtained from a point of sale terminal, although any transaction data can be utilized as appropriate to the requirements of specific applications of embodiments of the invention. For example, a consumer account can reload a prepaid card at a retailer; when the funds are deposited, advertising for the retailer can be presented to the consumer account via their client device. In many embodiments, the reload is received using a retailer system (such as a point of sale terminal 130). In several embodiments, the account servicing server system 110 provides targeting data to the retailer systems and/or receives targeting data and/or advertising data from the retailer systems. The targeting data can describe information about consumers that can be targeted and/or information about consumers that the retailer systems (and/or third party advertising systems) have requested as appropriate to the requirements of specific applications of embodiments of the invention. The account servicing server system 110 can utilize targeting data and/or advertising data to present offers to the client devices. These offers can be redeemed in a variety of ways in accordance with the requirements of specific applications of embodiments of the invention, including by providing a discount on a transaction for a target product and/or crediting funds to a transaction for the target product. In this way, the account servicing server system 110 can facilitate the purchase of target products by encouraging users to use the prepaid cards at participating retailers. Advertising data can be provided by third-party advertising systems (not pictured) and/or directly by the retailer systems as appropriate to the requirements of specific applications of embodiments of the invention. In several embodiments, the advertising data is provided based on targeting data provided by the account servicing server system 110.

Retailer systems, such as point of sale terminal 130, can be used to purchase prepaid cards, load fund onto the prepaid cards, as well as process consumer account transactions that use a consumer account's prepaid card to make purchases of goods and/or services from the retailer. The point of sale terminal 130 can transmit transaction data describing the requested transaction to the retailer server system 132 and/or the processor system 120. In many embodiments, the point of sale terminal 130 communicates directly with the account servicing system 110. In a variety of embodiments, the retailer server system 132 obtains transaction data from a number of point of sale terminals 130 and transmits the transaction data utilizing techniques similar to those described above.

Payment processor system 120 can process transactions on behalf of financial institution 140, retailer systems, card issuers, and many other types of financial institutions. In many embodiments, prepaid cards serviced by the account servicing server system 110 are associated with a particular payment processor system 120. In a variety of embodiments, the payment processor system 120 issues the prepaid cards (or any other account). Payment processor systems 120 provide a transaction interface that can be utilized to process transaction data. The transaction data can be obtained from any system, including the retailer system. In a number of embodiments, the payment processor system 120 processes transactions for prepaid cards (or any other account) issued by (or otherwise associated with) the payment processor system 120. Processing transaction data includes determining if a transaction should be authorized. If a transaction is authorized, funds drawn from an account associated with the prepaid card are directed to be transferred to an account associated with the retailer identified in the transaction. The transfer of funds can include transmitting requests to one or more financial institution systems 140 and/or the account servicing server system 110 in order to execute the requested transaction. Furthermore, transactions can include applying one or more offers to a particular transaction if the conditions for the offer are met by the transaction. In several embodiments, if the transaction is not authorized, the payment processor system 120 can request additional information from the account servicing server system 110. This additional information can then be utilized to re-process the transaction, potentially resulting in the transaction being authorized. For example, an offer can be applied (e.g. funds can be pre-authorized to be spent) to a transaction by the account servicing server system 110 by instructing the payment processor system 120 to authorize an additional amount based on the offer. The offer can then be redeemed at a later time in order to balance the account associated with the prepaid card in accordance with the terms of the offer.

In a variety of embodiments, payment processor systems 120 provide one or more account servicing interfaces to communicate with the account servicing server system 110 and/or financial institution system 140. The account servicing interface can be utilized by the account servicing server system 110 to obtain and/or transmit data to and from the payment processor system 120. For example, requests to issue accounts can be obtained using the account servicing interface. Similarly, if the payment processor system 120 needs additional information in order to process a transaction, that information can be requested and obtained from the account servicing server system 110 and/or the financial institution system 140. By way of example, the account servicing interface can be utilized to execute the offer application process described above based on transaction data obtained via the transaction interface. However, it should be noted that any processes that include communication between the payment processor system 120 and other systems within the account servicing system 100 can utilize the account servicing interface as appropriate to the requirements of specific embodiments of the invention.

Financial institution systems 140 include financial accounts for one or more entities. These financial accounts can hold funds on behalf of the entities and can transfer the funds to retailer systems, payment processors, account servicing server systems, or any other system as appropriate to the requirements of specific applications of embodiments of the invention. In many embodiments, financial institution systems 140 incorporate some or all aspects of the payment processor systems 120. In this way, financial institution systems can issue, service, and/or approve transactions related to prepaid cards. Additionally, funds can be deposited into accounts associated with a particular prepaid card based on offers honored by the account servicing server system 110. However, it should be noted that any technique for redeeming offers, including instructing financial institution systems 140 to accept funds from third-party offer fulfilment systems, can be utilized as appropriate to the requirements of specific applications of the invention.

Client devices can be used to manage account data associated with prepaid cards, purchase cards, add (e.g. reload) or remove funds from cards, purchase goods from a retailer, and any other transactions or operations as appropriate to the requirements of specific applications of embodiments of the invention. In many embodiments, the location of the client device (actual location, e.g. taken using a global positioning system receiver and/or wireless network location, and/or inferred location, based on the activity associated with the consumer account within a threshold time period) is utilized to target advertising to the consumer account. In a number of embodiments, client devices include a software application (or any other user identification data) that a consumer can sign on to in order to associate a particular consumer account with a client device. Furthermore, client devices can obtain and display advertising data transmitted to the device via any of a variety of techniques, including, but not limited to, on a request for advertising data, push notifications, email, short message service (SMS) messages, multimedia message service (MMS) messages. Client devices can also display the advertising data describing discounts (i.e. offers) and/or promotions and be used to accept the presented advertising as appropriate to the requirements of specific applications of embodiments of the invention. When the prepaid card associated with the account data is utilized to purchase the products associated with the accepted offers, the account servicing server system 110 provides (or causes to be provided by the payment processor system 120 and/or the financial institution 140) the appropriate credits and/or discounts to be applied to the particular transaction.

Although a specific architecture of an account servicing system in accordance with embodiments of the invention are discussed above and illustrated in FIG. 1, a variety of architectures, including client devices not specifically named and account servicing server systems that incorporate aspects of payment processor systems and/or financial institution systems, can be utilized in accordance with embodiments of the invention. Furthermore, it should be noted that any data created and/or transferred within the system can be provided by any system in any manner (i.e. via one or more application programming interfaces (APIs), web services, and/or file-based interfaces) as appropriate to the requirements of specific applications of embodiments of the invention. Systems and processes targeting and presenting advertising and conducting transactions in accordance with embodiments of the invention are described in more detail below.

### Account Servicing Server Systems

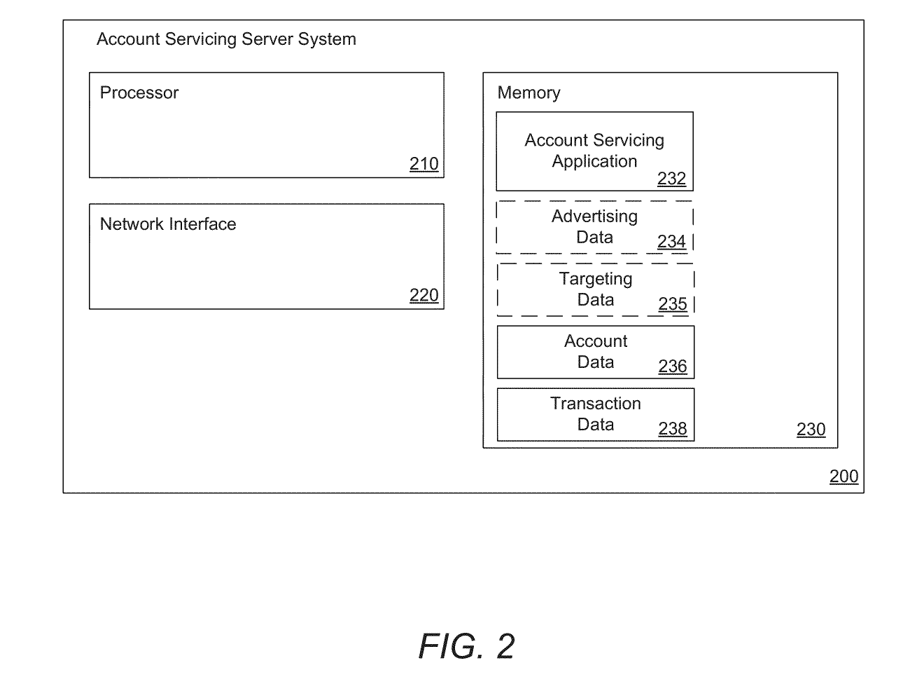

As described above, account servicing server systems can provide a variety of services for prepaid cards. One of these services includes causing advertising related to desired products to be presented to client devices associated with a prepaid card account. An account servicing server system in accordance with an embodiment of the invention is conceptually illustrated in FIG. 2. The account servicing server system 200 includes a processor 210 in communication with a network interface 220 and a memory 230. The network interface 220 is configured to send and receive data over a network connection. In a number of embodiments, the network interface 220 is in communication with the memory 230. In several embodiments, memory 230 is any form of storage configured to store a variety of data, including, but not limited to, an account servicing application 232, account data 236, transaction data 238, and in several embodiments, advertising data 234 and/or targeting data 235.

The account servicing application directs the processor 210 to perform a variety of account servicing processes. The account servicing processes include processing financial transactions for a consumer account, including reconciliation of debits and credits applied to a consumer account's account. The processes also include managing account data 236 describing the consumer account's account including, but not limited to, reload activity, balance activity, and location data, consumer account profile data, demographic data, employment information, credit status, income, mailing address, and/or any other consumer account pertinent information. Furthermore, consumer accounts can be identified by a set of identifying data, such as an account number, email address, phone number, and/or user identification data that can be utilized to target data. In this way, the account data can be utilized to target uniquely identifying pieces of information associated with the consumer. Account data 236 can also be associated with transaction data 238. Transaction data 238 can include data received from a variety of different sources, including the consumer account, retailers, payment processor systems, financial institution systems, and any other of a variety of other sources. The transaction data 238 can include purchase history, credits and deposits, available balance, among any other information as appropriate to the requirements of specific applications of the invention.

Account servicing processes can also include presenting advertisement via a client device. The advertisement can be transmitted to the client device via one or more pieces of advertising data and displayed based on the location and/or balance associated with the account associated with the client device. In a number of embodiments, the advertising data 234 is transmitted to a client device based on location of the consumer account and/or prior financial transactions of the consumer account. In a variety of embodiments, advertising data is generated and/or transmitted based on targeting data 235. Targeting data includes, but is not limited to, transaction data, location data, reload activity data, balance data, or any other information that can be utilized to specifically target a consumer account (or a class of consumer accounts) as appropriate to the requirements of specific applications of embodiments of the invention. In a number of embodiments, the advertising data 234 is received and/or transmitted from an external third-party resource, such as a retailer system or an advertiser system.

Although a specific architecture for an account servicing server system in accordance with an embodiment of the invention is conceptually illustrated in FIG. 2, any of a variety of architectures, including those that store data or applications on disk or some other form of storage and are loaded into memory at runtime, can also be utilized. In a variety of embodiments, the memory 220 includes circuitry such as, but not limited to, memory cells constructed using transistors, that are configured to store instructions. Similarly, the processor 210 can include logic gates formed from transistors (or any other device) that are configured to dynamically perform actions based on the instructions stored in the memory. In several embodiments, the instructions are embodied in a configuration of logic gates within the processor to implement and/or perform actions described by the instructions. In this way, the systems and methods described herein can be performed utilizing both general-purpose computing hardware and by single-purpose devices. A variety of account servicing processes in accordance with embodiments of the invention are discussed further below.

### Location-Based Advertising

A variety of account servicing processes include determining the location of a client device and providing advertising data to the client device. In many embodiments, the location of a client device is determined based on the location of a point of sale terminal used to reload a prepaid card associated with the client device. The advertising data can be pushed to the client devices in a variety of ways as appropriate to the requirements of specific applications of embodiments of the invention. The advertising data can be transmitted directly by account servicing server systems, third-party advertising systems, and/or retailers. Additionally, advertising data can be generated based on targeting data and transmitted by any of a variety of systems as described above.

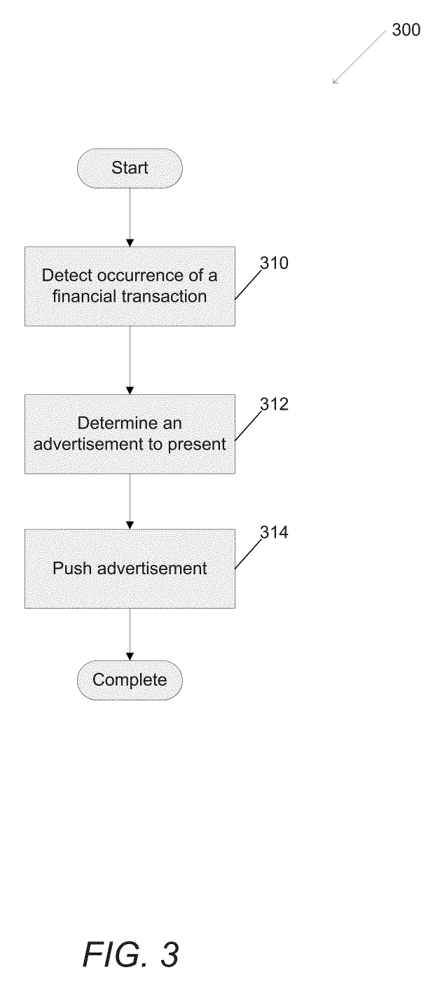

A process for pushing advertisements to a consumer account based on a detected location of the consumer account in accordance with embodiments of the invention is illustrated in FIG. 3. The process 300 includes detecting (310) financial transactions at a retailer location for a consumer account. In some embodiments, the process receives data associated with the financial transaction, including an amount of the transaction and a retailer store location and/or store identification data at which the transaction occurred. Financial transactions include, but are not limited to, reload activity. In this way, the financial transactions can provide both the location of a client device along with data describing the amount of money available to purchase goods. In a number of embodiments, the data is received at or near the particular time that the consumer account initiates the financial transaction. In several embodiments, the data can be received at a time interval (e.g., a few seconds and/or minutes) after the transaction has been initiated and/or completed. The financial transaction can be the purchase of a card managed by the account servicing server system. For example, a consumer account can activate a prepaid card (thereby registering the card and creating the appropriate accounts) at a retail location. The financial transaction can also be a reloading of funds onto an existing prepaid card account that is being managed by the account servicing server system. The data received by the account servicing system can be information regarding a notification that a consumer account is purchasing and/or reloading funds onto a card as well as data regarding the amount of money being loaded onto the card.

In a number of embodiments, the data is received from a retailer at which the financial transaction occurred. In particular, the financial transaction can be placed at a point of sale terminal located at the retailer and the retailer can send data regarding this transaction to the account servicing server system. In other embodiments, the data can be received from a different source associated with the processing of the financial transaction, such as a transaction processing system that handles the processing of cards on behalf of retailers. In many embodiments, the account servicing server system can analyze data received from various different sources to determine the occurrence of a financial transaction at a particular location. The precision with which the consumer account's location can be identified is typically dependent on the varying levels of specificity with which location is expressed in the received transaction data. Location can be expressed with varying precision as appropriate to the requirements of specific applications of the invention, such as identifying a retailer associated with the financial transaction (e.g., the consumer account is currently at a store operated by retailer), identifying a particular retail store location of the company at which of the financial transaction occurred (e.g., the consumer account is currently in retailer's store located at 100 Front Street, San Diego, Calif.), or even provide a particular level of specificity regarding the whereabouts of the consumer account within the particular retail store location, such as the particular point of sale terminal (e.g., cash register number #5) at which the consumer account conducted the financial transaction. Likewise, the data can identify a particular department that the consumer account is currently located within (e.g., the consumer account is in the household goods department at retailer's store). The particular level of specificity with respect to the consumer account's location can allow for useful information that can be utilized in determining the particular advertisements to present to a consumer account. For example, knowing the location of the consumer account within the retail store at a department level (e.g., household goods vs. men's clothing) can allow for the presentation of advertisements that are specific to goods and or services available within the particular department.

As described above, the financial transaction can be a purchase and/or reload of a card and the data can indicate the amount being placed on the card. In a number of embodiments, the process can also analyze data from other sources to verify the location of the consumer account. In particular, some embodiments can use a combination of data gathered from different sources in order to identify and/or verify the location of the consumer account with respect to the occurrence of a financial transaction, including any one of location data (e.g., GPS data, cellular location data) provided by the client device associated with an account (e.g. the prepaid card account), “check-in” data gathered from social media applications, and various other sources of location data as appropriate to the requirements of specific applications of embodiments of the invention.

Determining (312) one or more advertisements (i.e. offers) to provide to the consumer account can be based on the data received regarding the recent financial transaction and/or targeting data that sets forth the criteria for presenting advertisements to a consumer account. In a number of embodiments, determining (312) the advertisement to present based on a current location of the consumer account. Advertisements can be selected and/or generated based on the advertisement rules (i.e. targeting data) associated with the identified retailer location. In particular, in a number of embodiments, the process can use a set of advertising rule data that specify criteria for advertising to consumer accounts. For example, the rules can specify that if a consumer account is at a particular retailer location, then to select an advertisement from a particular set of advertisements associated with the retailer. Additional criteria can be set forth to further refine the particular advertisement that is selected as appropriate to the requirements of specific applications of embodiments of the invention.

In particular, in a number of embodiments, the amount of funds available on the prepaid card can be used to select an advertisement. For example, the advertisement can be selected such that the items and/or services offered within the advertisement are in a price range that is within a certain threshold of the funds available on the card. Thus if a consumer account loads $10 onto her prepaid card, the advertisement can present offers for items that are within a threshold range of $10. In a number of embodiments, as further described below, the advertisement can be selected based on the financial transactions of the consumer account. For example, if a consumer account typically purchases certain goods and/or services, the advertisement can be for those products and/or competitor products, depending on the particular advertising rule data being used.

The advertising data can be pushed (314) to the client device associated with the particular prepaid card. In certain embodiments, the client device can receive any one of a text message, phone call, email message, or other notification mechanism for presenting the advertisement and/or offer. In many embodiments, the consumer account can specify the particular notification protocol that the process can utilize to present offers to the consumer account. In a number of embodiments, the process pushes (i.e. transmits) the advertisement to a location within the retailer near the detected consumer account's location and the retailer can present the offer to the client device directly. In particular, the advertising data can be pushed to the point of sale terminal at which the financial transaction was processed. The advertisements and/or offers can then be presented (and/or printed) and given to the consumer account within the same period and location at which the consumer account loaded funds onto their card. For example, the consumer account can purchase or reload funds to a card and be provided with a receipt of the transaction and one or more advertisements and/or offers based on the amount of funds the consumer account loaded onto the card. In several embodiments, advertisements can be presented to the consumer account upon the consumer account requesting access to her account via a client device. In particular, some embodiments can present advertisements through a user interface provided by an online account management tool associated with the account.

Although specific process for presenting offers based on locations in accordance with embodiments of the invention are described above with respect to FIG. 3, any number of processes, including those that use additional location information and other types of information in targeting advertising to present a consumer account, can be utilized as appropriate to the requirements of specific applications in accordance with embodiments of the invention.

### Targeting Advertising Utilizing Third-Party Advertisers

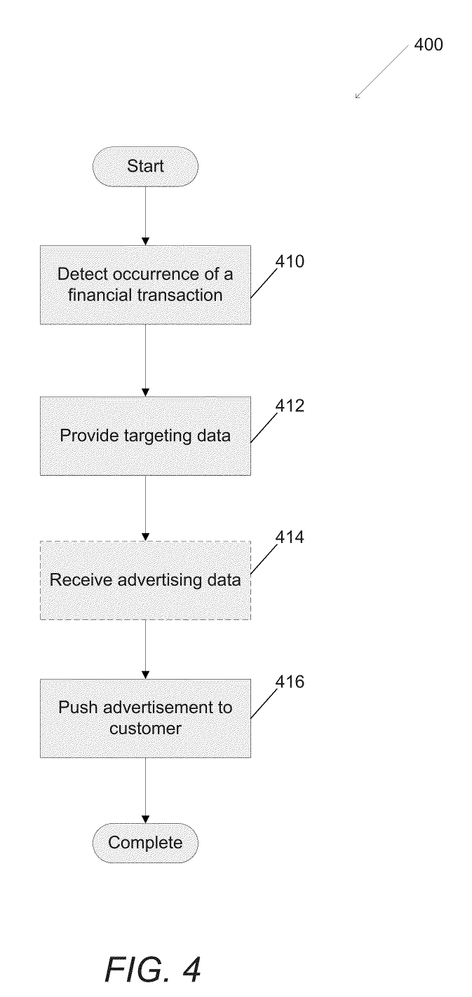

As described above, advertising data can be pushed to client devices based on a detected real-time location of the consumer account, thereby providing consumer accounts with advertisements that can be particularly useful to the consumer account based on the goods and/or services available near the current location of the consumer account. In many embodiments of the invention, the account servicing system can communicate with one or more third-party advertising systems in order to determine one or more advertisements to present to a consumer account based on the location and reload data. Account servicing processes can include targeting advertising using third-party advertisers. A process for selecting and presenting advertisements to consumer accounts via third-party advertisers in accordance with an embodiment of the invention is illustrated in FIG. 4. The process 400 includes detecting (410) the occurrence of a financial transaction at a retailer location for a consumer account via any of a variety of techniques, including those described above. Targeting data can be generated and provided (412) to one or more third-party advertising systems. The targeting data can include metadata describing the financial transaction(s), such as the amount of money reloaded onto the prepaid card, in addition to the location data. In a number of embodiments, the third-party advertisers can be retailers, companies, service providers, and/or advertising agencies associated with the particular retail location at which the consumer account initiated the financial transaction. In a variety of embodiments, the targeting data can include user identification data and/or client device identification data. This identification data can, in many embodiments, be linked to one or more accounts provided by third-party services, such as online social networks and/or advertising networks. The identification can then be utilized by the third-party systems to further target and/or displaying advertising as appropriate to the requirements of specific applications of embodiments of the invention. For example, if the targeting data includes identification data that can be utilized to identify an online social network account, the advertising data can be displayed as a message within the online social network, either directed to the consumer's account and/or posted on the consumer's account. Similarly, advertising can be directed across a variety of websites when the targeting data includes identification data that can be utilized by an advertising network to identify a consumer (or their client device) across one or more websites.

In many embodiments, the process can notify other third-party advertisers and/or retailers based on a set of advertising rule data that are applicable for the identified consumer account location. For example, the process can notify one or more companies that have goods and/or services offered at the particular retailer at which the financial transaction occurred. For example, if the financial transaction occurred at a first retailer, the process can notify one or more third party companies that provide products and/or services offered by the retailer and/or the specific location. The companies notified can also be one or more competitors that can try to divert business away from the retailer. For example, if the process detects that a consumer account is currently at Retailer A, the advertising rule data can specify presenting advertisements for Retailer B. The particular companies and/or parties that can be notified upon the occurrence of the financial transaction can vary based on the particular set of advertising rule data that have been specified and/or relationships established between the various parties and the account servicing server system. Additionally, any of the data described above including, but not limited to, information regarding the amount of funds loaded onto the card of the consumer account, the point of sale terminal at which the funds were loaded, various consumer account data (e.g., consumer account profile, credit profile, transaction history, among various other information), among other data can be provided as appropriate to the requirements of specific applications of embodiments of the invention.

In a variety of embodiments, advertising data is received (414). The advertising data can also include an offer to be presented to the consumer account via one or more advertising channels. In a number of embodiments, the advertisement to be presented to the consumer account can be selected by the advertiser, retailer, and/or company that was notified of the occurrence of the financial transaction. For example, if $200 was reloaded onto the prepaid card, advertising data that provides an offer for a television on sale for $200 can be provided. This allows for the real-time analysis of many different types of information that can be used to target an advertisement to a particular consumer account, including information regarding a consumer account's current real-time location, the amount of funds currently available for the consumer account to use, the consumer account's transaction and spending history, among various other information, and thus the offers that are to be presented to the consumer account can be tailored to maximize their effectiveness according to the consumer account's most likely needs.

Advertisements can be pushed (416) to the client device utilizing any of a variety of techniques, including those described above. Furthermore, as will be described in additional detail below, in a number of embodiments, the process tracks the offers presented to consumer accounts to see if any future purchases of the consumer account fit the criteria of the offers that were made, and if they do fit the criteria, automatically redeem the offers on the consumer account's behalf.

Specific processes for real-time selection and presentation of offers in accordance with embodiments of the invention are described above with respect to FIG. 4; however, any number of processes can be utilized as appropriate to the requirements of specific applications in accordance with embodiments of the invention.

### Transaction-Based Targeted Advertising

In order to increase the possible relevance of the advertisements being presented to consumer accounts, many embodiments can analyze the transaction histories of consumer accounts in order to determine products and/or services that can be of interest to the consumer account. Combining the location information of the consumer account with offers that are selected based on a consumer account's purchase history can maximize the likelihood that a consumer account will act upon an offer that is presented. Account servicing processes in accordance with embodiments of the invention can include targeting advertising based on the transaction history associated with a prepaid card.

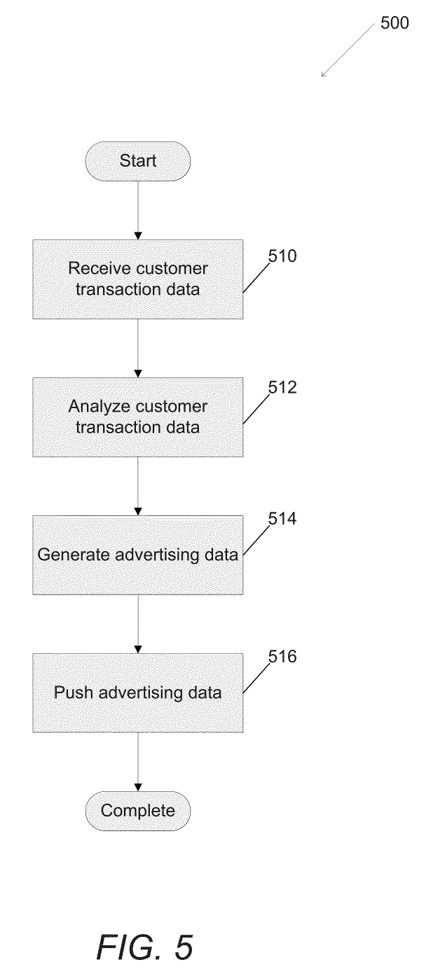

A process for targeting and/or presenting advertising based on financial transactions of a consumer account in accordance with an embodiment of the invention is illustrated in FIG. 5. The process 500 includes receiving (510) consumer account financial transaction data. In a number of embodiments, the financial transaction data can be received from any one or combination of retailers (both physical and online), card processors, and/or any other systems that can be involved with the processing of financial transactions. Furthermore, different data can be received from different parties. For example, data regarding the purchase amount, items purchased, and store location can be received from a system associated with the retailer, while other information, such as the card account information, can be received from a card processor that processed the purchase. The process can store the consumer account transaction data in a database or other external server as needed to manage the consumer account's card account.

The financial transaction data can include various different pieces of information, including purchases and/or credits made by the consumer account, a retail location of the transaction, the amount of the transaction, a list of items being purchased for the transaction, date, and/or time of transaction, among various other pieces of information. In a number of embodiments, the process can receive a “shopping cart” data describing items purchased at a retailer, with a description of each item, the cost of the item, and any other data describing the transaction.

Consumer account transactions are analyzed (512) to determine one or more offers to make to the consumer account. In a number of embodiments, the process applies a set of advertisement rules to the consumer account transactions in determining which offers should be made in the future. In a number of embodiments, the process analyzes any combination of (i) the type of goods and/or services purchased, (ii) the frequency of the purchases, (iii) the amount of money spent on purchases, (iv) the time of day/day of week that purchases are made, (v) the retail locations of the purchases, and any other criteria as appropriate to the requirements of specific applications of the invention.

Furthermore, advertising rule data obtained from retailers and/or other parties can be utilized to determine the criteria to use to target advertising to particular (groups of) consumer accounts. In many embodiments, a retailer can specify a marketing campaign targeted to consumer accounts that have certain characteristics. For example, the retailer can specify that it would like to present an offer for a particular discounted television to all consumer accounts that are detected within one of the retail store locations of the retailer, and that those consumer accounts have at least $1000 to spend (i.e. loaded onto a prepaid card), have not purchased a television in the last 12 months, and are between the age of 18-35. Based on this set of advertising rule data, the process can analyze a consumer account's data when the consumer account is detected within a retail store location, including the consumer account's financial and transaction data, to see if the consumer account satisfies these criteria in prior to sending the particular offer to the consumer account. As can be readily appreciated, the advertising rule data can be tailored across many different dimensions and retailers can narrow or broaden the rules according to their preferences. By using the consumer account's purchasing history, retailers can be able to obtain valuable information that can be used to better market their products and/or services to consumer accounts to both increase sales and to provide a savings to these consumer accounts. In this way, the targeting data can be coupled with the advertising rule data presented by consumers to precisely target specific advertisements to specific consumer accounts.

This data, along with any other data appropriate to the requirements of specific applications of embodiments of the invention, can be utilized to generate (514) advertising using any techniques, including techniques similar to those described above. Similarly, advertising data can be pushed (516) to client devices associated with the consumer account utilizing techniques similar to those described above.

Although specific process for presenting advertising data based on historical transactions in accordance with embodiments of the invention are described above with respect to FIG. 5, any number of processes can be utilized as appropriate to the requirements of specific applications in accordance with embodiments of the invention.

### Offer Redemption

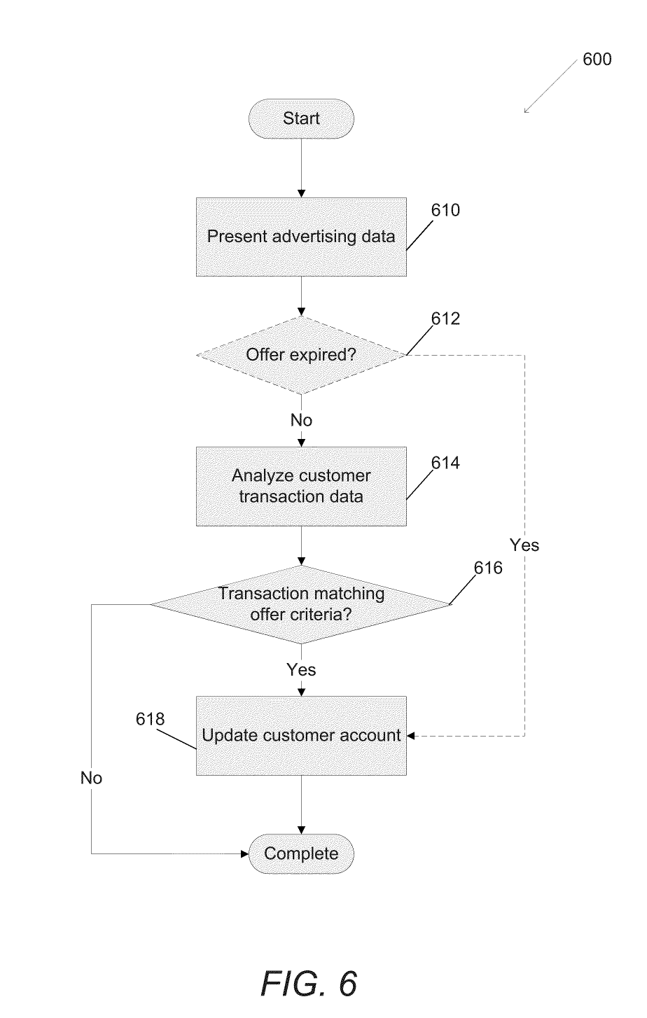

As described above, consumer accounts often miss enormous savings that could otherwise have been obtained on purchases had the consumer account been aware of offers and/or offers available to them. Many consumer accounts forego this time consuming process and therefore miss many valuable savings opportunities. In several embodiments, account servicing processes allow consumer accounts to obtain a savings without any further action required on the part of the consumer account. As such, the consumer account can simply purchase items using their prepaid card; offers that had been presented to the consumer account can be automatically applied to these transactions and the savings automatically redeemed for the consumer account. Similarly, consumer accounts can opt-in to particular offers based on advertisements provided to the user via a client device. A process for automatic offer redemption in accordance with an embodiment of the invention is illustrated in FIG. 6. The process 600 includes presenting (610) an advertisement to a consumer account. The advertisement can be an offer for goods and/or services. The offer can also provide an offer redeemable by any number of mechanisms, including presentation at the time of purchase. For example, the offer can be in electronic form and presentable on a mobile device of the consumer account.

In several embodiments, a determination is made (612) whether or not the offer has expired. If the offer has not expired, consumer account transaction data is analyzed (614). In a number of embodiments, the consumer account transaction data can be received upon a consumer account engaging in a financial transaction and/or stored in a transaction database. In a number of embodiments, the transaction data can be received from one or more systems associated with the processing of the financial transaction. In a number of embodiments, the transaction data can be a list of items and/or services purchased and this information can be provided by the retailer. In particular, certain data regarding the financial transaction can be obtained from the retailer, such as the list of items being purchased. Likewise, a third-party card processor can provide a total dollar amount of the financial transaction, without being able to identify the individual items being purchased. Thus, the process can use a combination of data from different sources with respect to a financial transaction.

If one or more transactions satisfy (616) the criteria of one or more offers, the process updates (618) the consumer account based upon the offer rewards. For example, if an offer was presented to a consumer account for 25% off a television purchased at Retailer A available for the next 3 days, the process would determine whether any transactions occurred at Retailer A for the particular type of television during the specified period. In a number of embodiments, the process can add funds to the consumer account's card account based on the offer criteria. In a variety of embodiments, the retailer system can be notified to discount the item at the time of purchase. In many embodiments, a payment processor system is instructed to authorize a transaction exceeding the balance available on the prepaid card by the amount of the offer. By automatically redeeming offers and applying offers to consumer account transactions, the consumer account can simply make purchases knowing that their outstanding offers and/or offers will be applied to the purchases.

Specific process for redeeming offers in accordance with embodiments of the invention are described above with respect to FIG. 6; however, any number of processes, including those that mark offers as redeemed and those that apply offers to transactions utilizing techniques other than those specifically described above, can be utilized as appropriate to the requirements of specific applications in accordance with embodiments of the invention.

Although the present invention has been described in certain specific aspects, many additional modifications and variations would be apparent to those skilled in the art. In particular, any of the various processes described above can be performed in alternative sequences and/or in parallel (on the same or on different computing devices) in order to achieve similar results in a manner that is more appropriate to the requirements of a specific application. It is therefore to be understood that the present invention can be practiced otherwise than specifically described without departing from the scope and spirit of the present invention. Thus, embodiments of the present invention should be considered in all respects as illustrative and not restrictive. Accordingly, the scope of the invention should be determined not by the embodiments illustrated, but by the appended claims and their equivalents.

What is claimed is:

1. A method for targeting advertising, comprising:
obtaining financial transaction data using an account servicing server system, wherein:
the financial transaction data comprises location data, retailer identification data, and metadata describing reload activity for a prepaid card; and
the reload activity comprises metadata describing the amount of money deposited in an account associated with the prepaid card;
generating targeting data based on the location data, retailer identification data, and the reload activity using the account servicing server system;
obtaining advertising data based on the generated targeting data using the account servicing server system, wherein the advertising data comprises at least one offer for a product provided by the retailer identified by the retailer identification data; and
providing the advertising data using the account servicing server system.

2. The method of claim 1, wherein:
the method further comprises identifying a client device associated with the prepaid card based on the financial transaction data using the account servicing server system; and
the advertising data is provided to the client device.

3. The method of claim 2, wherein providing the advertising data further comprises:
transmitting the targeting data to a third party advertising system using the account servicing server system; and
transmitting the advertising data to the client device using the third-party advertising system.

4. The method of claim 1, wherein the advertising data is provided to a point of sale terminal located at the retailer identified based on the retailer identification data.

5. The method of claim 4, wherein the point of sale terminal is identified based on the financial transaction data.

6. The method of claim 4, wherein the advertising data is utilized to generate an offer redeemable via the point of sale terminal using the point of sale terminal.

7. The method of claim 1, further comprising:
obtaining a set of advertising rule data using the account servicing server system, wherein the advertising rule data comprises mappings of product data to offer data;
generating the targeting data based on the advertising rule data, wherein the generated targeting data comprises offer data for products selected based on the financial transaction data and the offer data; and
obtaining advertising data comprising at least one offer for the products described by the advertising rule data.

8. The method of claim 7, wherein the advertising rule data is provided by a retailer system associated with the retailer identified by the retailer identification data.

9. The method of claim 7, wherein the advertising rule data is provided by a third-party retailer system separate and distinct from the retailer identified by the retailer identification data.

10. The method of claim 9, wherein the obtained advertising data further comprises retailer data identifying a third-party retail location that is located within a threshold distance from the retailer identified in the financial transaction data.

11. The method of claim 7, wherein the advertising rule data is provided by a third-party advertising system.

12. The method of claim 1, wherein the advertising data is provided by pushing the advertising data to a client device using the account servicing server system.

13. The method of claim 12, wherein the advertising data is pushed to the client device using a short message service message.

14. The method of claim 1, further comprising:
obtaining transaction verification data using the account servicing server system, wherein the transaction verification data comprises metadata describing that a second financial transaction data has been denied and product data describing a product to be purchased via the second financial transaction;
determining that an offer associated with the advertising data corresponds to the product to be purchased using the account servicing server system; and
transmitting transaction authorization data using the account servicing system.

15. The method of claim 14, wherein the transaction verification data is obtained from a payment processor system.

16. The method of claim 14, wherein the transaction authorization data is transmitted to a financial institution system, wherein the financial institution system holds the account associated with the prepaid card.

17. The method of claim 14, wherein the overage is equivalent to the amount of the discount applied to the product to be purchased calculated based on price data describing the cost of the product to be purchased and the offer data.

18. The method of claim 14, further comprising:
transmitting deposit data to a financial institution system holding the account associated with the prepaid card using the account servicing server system, wherein the deposit data comprises an amount of money to be deposited into the account based on the offer data; and
the transaction authorization data comprises instructions to a payment processor system to re-execute the second financial transaction.

19. The method of claim 14, wherein the transaction authorization data comprises metadata describing an authorization to allow an overage on the second financial transaction based on the offer data.

20. An account servicing server system, comprising:
a processor; and
memory connected to the processor and storing an account servicing application;
wherein the account servicing application directs the processor to:
obtain financial transaction data, wherein:
the financial transaction data comprises location data, retailer identification data, and metadata describing reload activity for a prepaid card; and
the reload activity comprises metadata describing the amount of money deposited in an account associated with the prepaid card;
generate targeting data based on the location data, retailer identification data, and the reload activity;
obtain advertising data based on the generated targeting data, wherein the advertising data comprises at least one offer for a product provided by the retailer identified by the retailer identification data; and
provide the advertising data.
